(19) United States
(12) Patent Application Publication
(10) Pub. No.: US 2020/0077639 A1
(43) Pub. Date: Mar. 12, 2020

(54) HUNTING STAND ACCESSORY MOUNTING RAIL SYSTEM

(71) Applicant: Roger Neal Blaha, Canton, MI (US)

(72) Inventor: Roger Neal Blaha, Canton, MI (US)

(21) Appl. No.: 16/244,578

(22) Filed: Jan. 10, 2019

Related U.S. Application Data
(60) Provisional application No. 62/727,893, filed on Sep. 6, 2018.

(51) Int. Cl. A01M 31/02

(52) U.S. Cl. CPC A01M 31/02

(57) ABSTRACT

A hunting stand includes an accessory mounting rail system. The hunting stand includes a track rail mounted to the hunting stand including an elongated fastener channel configured to mount an accessory thereto and permit the accessory to be moved along the elongated fastener channel. The hunting stand can be a tree stand or a free-standing hunting stand. The hunting stand can include one or a plurality of track rails.

### CROSS-REFERENCE TO RELATED APPLICATIONS

This disclosure claims the benefit of U.S. Provisional Patent Application No. 62/727,893 which was filed on Sep. 6, 2018, which is hereby incorporated by reference.

### TECHNICAL FIELD

This disclosure is related to a device useful in hunting sports, in particular, to a stand useful to aid a hunter in quietly waiting for a game animal to enter an area.

### BACKGROUND

The statements in this section merely provide background information related to the present disclosure. Accordingly, such statements are not intended to constitute an admission of prior art.

Tree stands and elevated hunting stands are known in the art. They are useful to permit a hunter to sit off of the ground and wait quietly for a game animal to enter an area in front of the stand. Staying quiet for long periods of time is problematic. A hunter can wait hours or a whole day waiting for an animal to wander by. In this time, the hunter cannot physically hold a gun, bow, or crossbow for an indeterminate amount of time without becoming fatigued. When an animal does enter the area being watched, the hunter may only have seconds to acquire the hunting weapon, bring it up to aim, and accurately deliver the bullet, arrow, or bolt to the hunted animal. As a result of this time sensitive operating of bringing the weapon to bear, only the most skilled hunters can do so without panicking or making excessive noise when acquiring and bringing the weapon to bear. Further, keeping a loaded gun or crossbow in a tree stand can be dangerous. The hunter may feel the need to keep the weapon balanced precariously in order to keep it as close to possible to the firing position.

### SUMMARY

A hunting stand includes an accessory mounting rail system. The hunting stand includes a track rail mounted to the hunting stand including an elongated fastener channel configured to mount an accessory thereto and permit the accessory to be moved along the elongated fastener channel. The hunting stand can be a tree stand or a free-standing hunting stand. The hunting stand can include one or a plurality of track rails.

### BRIEF DESCRIPTION OF THE DRAWINGS

One or more embodiments will now be described, by way of example, with reference to the accompanying drawings, in which:

FIG. 1 illustrates an exemplary tree stand including an accessory mounting rail system in perspective view, in accordance with the present disclosure;

FIG. 2 illustrates the tree stand of FIG. 1 from a side view, in accordance with the present disclosure;

FIG. 3 illustrates the tree stand of FIG. 1 from a front view, in accordance with the present disclosure;

FIG. 4 illustrates an alternative exemplary embodiment of a tree stand including an accessory mounting rail system, with multiple track rails mounted at various locations around the tree stand, in accordance with the present disclosure;

FIG. 5 illustrates the accessory mounting rail system of FIG. 1 in cross section, including a track rail with a mounting face oriented ninety degrees from a track runner face, in accordance with the present disclosure;

FIG. 6 illustrates an exemplary alternative track rail in cross section, with a mounting face coplanar with a track runner face, in accordance with the present disclosure;

FIG. 7 illustrates an exemplary alternative track rail in cross section, with three tracks oriented in three separate directions, in accordance with the present disclosure;

FIG. 8 illustrates an exemplary tree stand similar to the tree stand of FIG. 4 with a plurality of exemplary accessories attached to the accessory mounting rail system, in accordance with the present disclosure;

FIG. 9 illustrates an exemplary accessory including foliage useful as a blind, in accordance with the present disclosure;

FIG. 10 illustrates in side view an exemplary accessory including a weapon rack, in accordance with the present disclosure;

FIG. 11 illustrates in front view the weapon rack of FIG. 10, in accordance with the present disclosure;

FIG. 12 illustrates photographically a tree stand including an accessory mounting rail system including a plurality of generic accessory attachment blocks, in accordance with the present disclosure;

FIG. 13 illustrates photographically the tree stand of FIG. 12 with three foliage decorations installed to the generic accessory attachment blocks, in accordance with the present disclosure;

FIG. 14 illustrates photographically a tree stand including an accessory mounting rail system including an empty crossbow rack assembly, in accordance with the present disclosure;

FIG. 15 illustrates photographically the tree stand of FIG. 14 with a crossbow loaded into the crossbow rack assembly, in accordance with the present disclosure;

FIG. 16 illustrates photographically a tree stand including an accessory mounting rail system including a bow rack assembly, in accordance with the present disclosure;

FIG. 17 illustrates photographically the tree stand of FIG. 16 with a bow loaded into the bow rack assembly, in accordance with the present disclosure;

FIG. 18 illustrates photographically from a top view a tree stand including an accessory mounting rail system including rapid change fastener knobs, in accordance with the present disclosure;

FIG. 19 illustrates photographically from a side view the tree stand of FIG. 18 with a knick-knack basket attached as an accessory, in accordance with the present disclosure;

FIG. 20 illustrates photographically in a magnified scale the tree stand of FIG. 18, showing the rapid change fastener knobs in greater detail, in accordance with the present disclosure;

FIG. 21 illustrates an exemplary free-standing hunter stand including an accessory mounting rail system, in accordance with the present disclosure;

FIG. 22 illustrates photographically an alternative embodiment of a free-standing hunter stand including an accessory mounting rail system including adjustable height railings, with the railings in an upper position, in accordance with the present disclosure;

FIG. 23 illustrates photographically the free-standing hunter stand of FIG. 22, with the railings in a lower position, in accordance with the present disclosure;

FIG. 24 illustrates photographically from a side view the tree stand of FIG. 18 with a camera device attached as an accessory, in accordance with the present disclosure;

FIG. 25 illustrates in cross section an exemplary alternative configuration to the accessory mounting rail system of FIG. 20, in accordance with the present disclosure;

FIG. 26 illustrates in side view an exemplary alternative free-standing hunter stand including an accessory mounting rail system of FIG. 21, with adjustable height railings, in accordance with the present disclosure;

FIG. 27 illustrates photographically an exemplary alternative hunting stand including an alternative floor platform, in accordance with the present disclosure;

FIG. 28 illustrates photographically an exemplary alternative hunting stand including alternative exemplary accessories mounted thereto, in accordance with the present disclosure;

FIG. 29 illustrates photographically an additional exemplary alternative hunting stand including alternative exemplary accessories mounted thereto, in accordance with the present disclosure;

FIG. 30 illustrates photographically the tree stand of FIG. 20, with the track rail removed for purposes of illustrating components of the rapid change fastener knobs, in accordance with the present disclosure;

FIG. 31 illustrates photographically an additional exemplary alternative hunting stand including an exemplary crossbow rack and crossbow mounted thereto, in accordance with the present disclosure;

FIG. 32 illustrates photographically an additional exemplary alternative hunting stand including an exemplary rifle rack and rifle mounted thereto, in accordance with the present disclosure;

FIG. 33 illustrates photographically an additional exemplary alternative hunting stand including alternative exemplary accessories mounted thereto, in accordance with the present disclosure;

FIG. 34 illustrates the tree stand and accessory mounting rail system of FIG. 4, with a track rail mounted on the vertical strut of the tree stand, in accordance with the present disclosure; and

FIG. 35 illustrates an alternative version of the disclosed tree stand, with one or more of the structural members of the tree stand being formed with track rail members, in accordance with the present disclosure.

### DETAILED DESCRIPTION

A hunting stand improved with an accessory mounting rail system is disclosed which enables any accessory that a hunter needs to be mounted within easy reach of the hunter. The mounted accessories can be fit within a fastener slot or similarly accommodating mounting feature such that the accessory can be adjusted to different locations along the accessory mounting rail system based upon the preference of the hunter.

A wide variety of hunting accessories are envisioned for use with the disclosed accessory mounting rail system. A weapon rack can be utilized, where the hunter's weapon (a rifle, shotgun, handgun, bow, crossbow, etc.) can be situated in a near-ready position, such that when game wanders into range, the hunter can easily and quietly access the weapon from the rack and prepare to shoot at the game. A hunter's blind accessory can provide cover for the hunter, for example, erecting a nylon camouflage sheet or foliage branches around the hunting stand. A quiver or ammunition case accessory can provide access to ammunition for the hunter. A weatherproof phone stand accessory can provide the hunter not only with a place to safely store a cellular device, but can also provide the hunter with access to the screen of the device while hunting, for example, to provide a time, a temperature, a weather report, etc. to the hunter while he or she is quietly sitting in the stand. Other accessories are envisioned, and the disclosure is not intended to be limited to the exemplary embodiments provided herein.

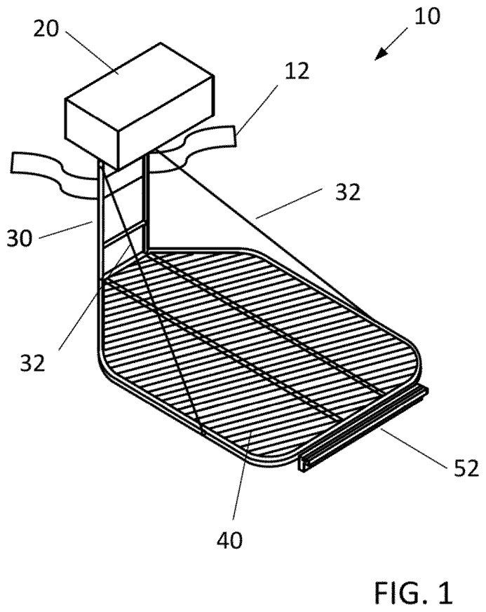

Referring now to the drawings, wherein the showings are for the purpose of illustrating certain exemplary embodiments only and not for the purpose of limiting the same, FIG. 1 illustrates an exemplary tree stand including an accessory mounting rail system in perspective view. Tree stand 10 illustrates one exemplary type of hunting stand. Seat 20 is suspended over floor platform 40 with strut 30. Exemplary tree attachment band 12 is illustrated for attaching tree stand 10 to a neighboring tree. Cables 32 are used to support platform 40. An accessory mounting rail system is illustrated including track rail 52 attached along a front edge of platform 40. Track rail 52 includes an elongated fastener channel configured to receive an accessory device and enable the accessory device to be fastened securely to the track rail.

Platform 40 can have any known support surface useful for a person to stand upon. The platform can include an open, cross hatched welded metal wire design. In another embodiment, the platform can include a metallic flat surface, in some instances including raised or etched surfaces increasing traction upon the surface.

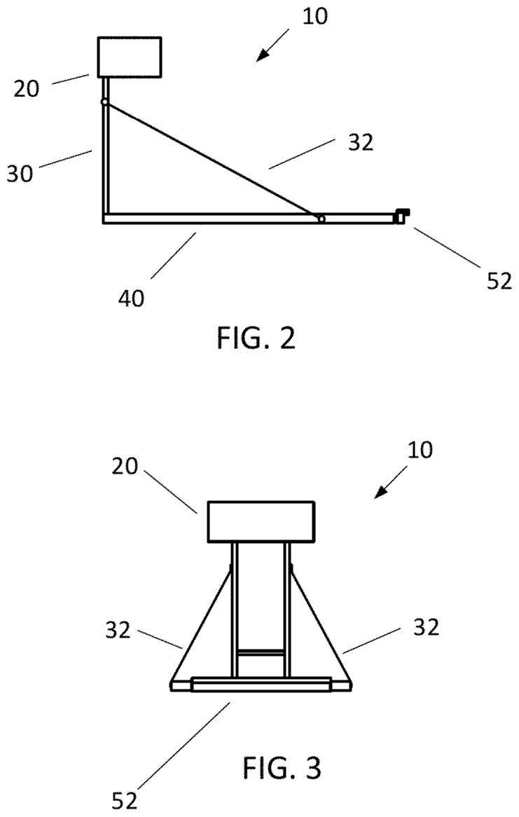

FIG. 2 illustrates the tree stand of FIG. 1 from a side view. Tree stand 10 includes seat 20, platform 40, strut 30, and cables 32. Accessory mounting rail system is illustrated including track rail 52. FIG. 3 illustrates the tree stand of FIG. 1 from a front view. Tree stand 10 includes seat 20, cables 32, and track rail 52.

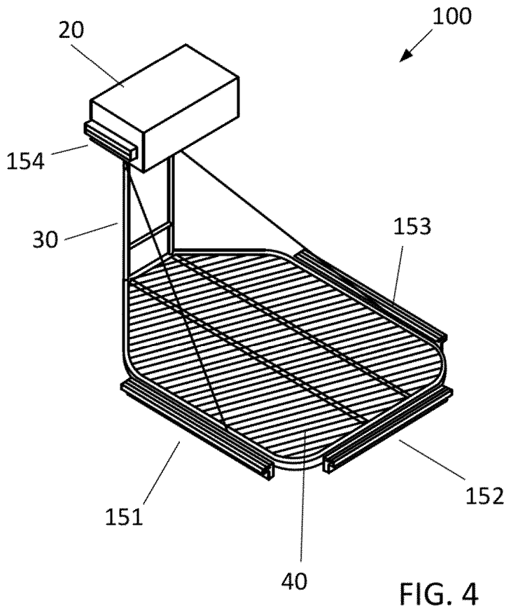

FIG. 4 illustrates an alternative exemplary embodiment of a tree stand including an accessory mounting rail system, with multiple track rails mounted at various locations around the tree stand. Tree stand 100 illustrates a hunting stand similar to the hunting stand of FIG. 1. Tree stand 100 includes seat 20 suspended over platform 40 with strut 30. Cables 32 are used to support platform 40. An accessory mounting rail system is illustrated including track rails 151, 152, and 153 attached along a perimeter of platform 40. The accessory mounting rail system further includes track rack 154 mounted to a side of seat 20.

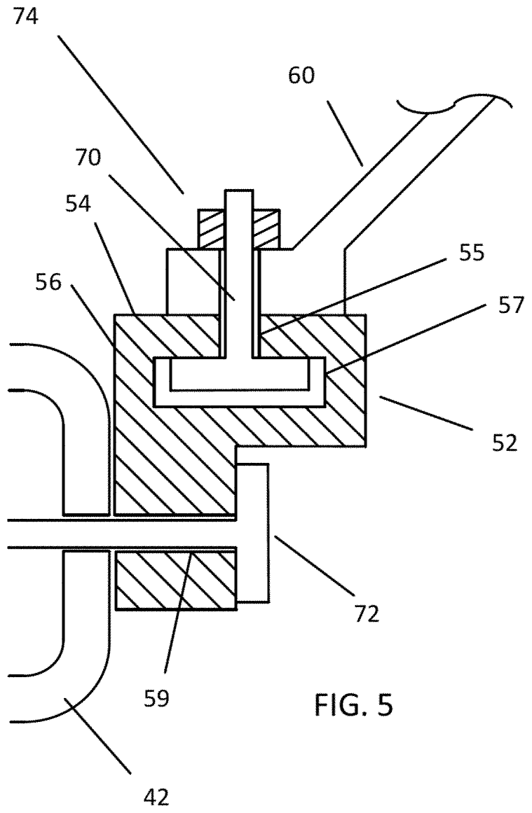

FIG. 5 illustrates the accessory mounting rail system of FIG. 1 in cross section, including a track rail with a mounting face oriented ninety degrees from a track runner face. Track rail 52 is illustrated in sectional profile attached to perimeter tube 42 of the platform of the hunting stand. Track rail 52 includes track runner face 54 including narrow opening 55 and elongated fastener channel 57 which runs a longitudinal length of track rail 52. Mounting face 56 mounts flush against perimeter tube 42. Fastener 72 extends through mounting hole 59 of track rail 52 to attach track rail 52 to perimeter tube 42. Accessory connection arm 60 is illustrated attached to track rail 52 with fastener 70. Fastener 70 includes a wide head situated within channel 57 of track rail 52, with a post of fastener 70 extending through narrow opening 55. Nut 74 fastens accessory connection arm 60 to fastener 70.

Channel 57 and narrow opening 55 run along an entire length of track rail 52. Fastener 70 can be tightened to secure arm 60 in one location or loosened to permit adjustment of arm 60 along channel 57.

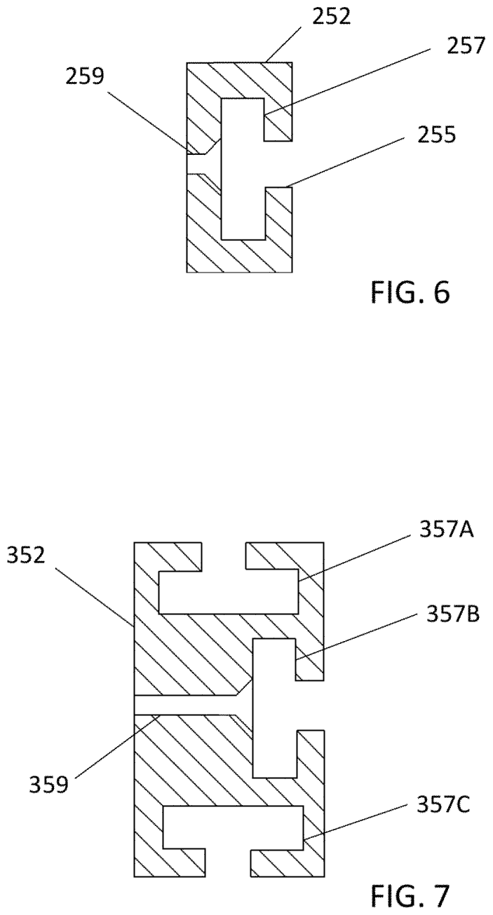

FIG. 6 illustrates an exemplary alternative track rail in cross section, with a mounting face coplanar with a track runner face. Track rail 252 is illustrated in sectional profile including elongated fastener channel 257 and narrow opening 255. Channel 257 and narrow opening 255 run along an entire length of track rail 252. Connected accessory devices mounting to track rail 252 can be slidingly adjusted along channel 257. Mounting hole 259 of track rail 252 enables attachment of track rail 252 to a neighboring structure of a hunting stand.

FIG. 7 illustrates an exemplary alternative track rail in cross section, with three tracks oriented in three separate directions. Track rail 352 is illustrated in sectional profile including elongated fastener channels 357A, 357B, and 357C and respective narrow openings. Channels 357A, 357B, and 357C run along an entire length of track rail 352. Connected accessory devices mounting to track rail 352 can be fit within any of the channels and slidingly adjusted along the selected channel. Mounting hole 359 of track rail 352 enables attachment of track rail 352 to a neighboring structure of a hunting stand.

FIGS. 5-7 illustrate exemplary track rails that can be utilized in the disclosed accessory mounting rail systems. Any number of configurations, shapes, and designs of alternative track rails can be substituted for the illustrated examples, and the disclosure is not intended to be limited to the particular examples provided herein.

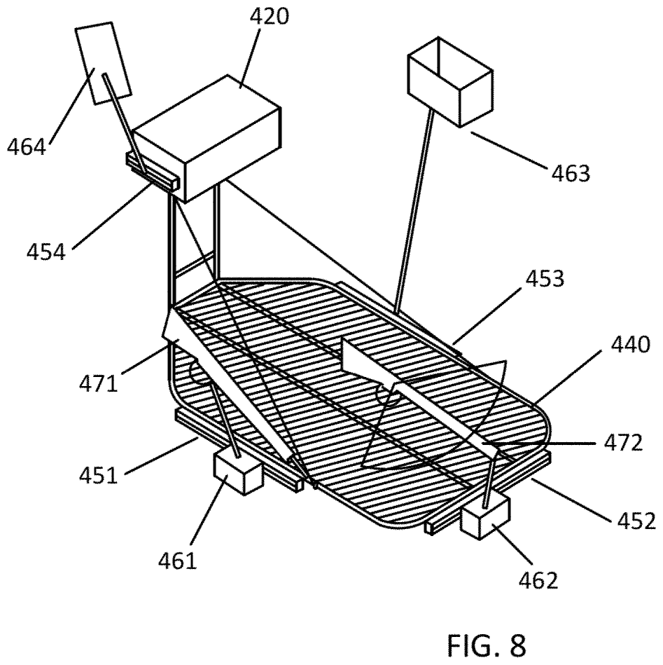

FIG. 8 illustrates an exemplary tree stand similar to the tree stand of FIG. 4 with a plurality of exemplary accessories attached to the accessory mounting rail system. The illustrated hunting stand includes seat 420 and platform 440. The hunting stand includes an accessory mounting rail system including track rails 451, 452, and 453 attached around a perimeter of platform 440 and a track rail 454 attached to a side of seat 420. An exemplary accessory device 461 is attached to track rail 451 including a rack for rifle 471. An exemplary accessory device 462 is attached to track rail 452 including a rack for crossbow 472. An exemplary accessory device 463 is attached to track rail 453 including a knick-knack basket. An exemplary accessory device 464 is attached to track rail 454 including a cell phone holder. The hunting stand and the arrangement of attached accessories are exemplary and non-limiting, numerous alternative configurations and accessory attachments are envisioned, and the disclosure is not intended to be limited to the particular examples provide herein.

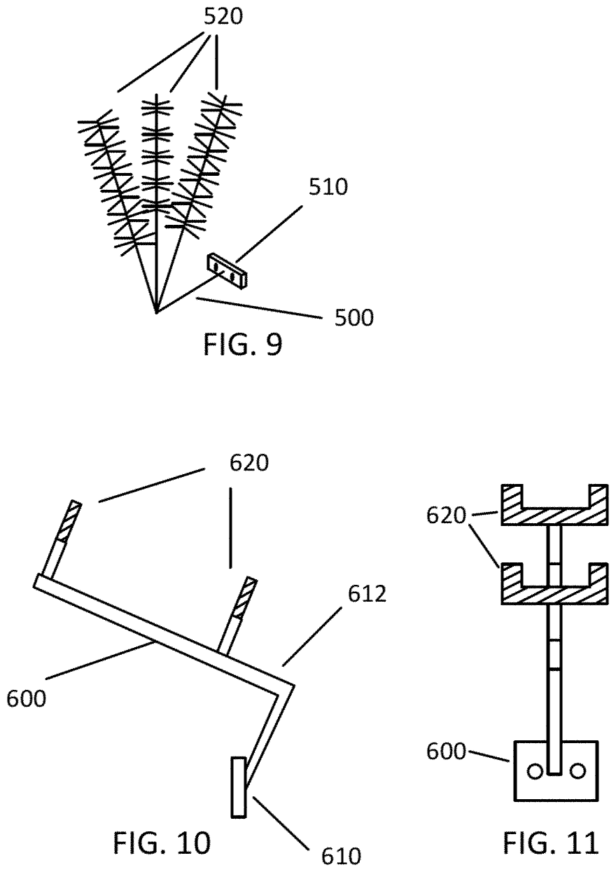

FIG. 9 illustrates an exemplary accessory including foliage useful as a blind. Foliage accessory 500 includes attachment plate 510 configured to be attached to a rail and foliage 520. Foliage 520 can include artificial or fake foliage (plastic Christmas tree branches, for example) or can include bracketry for the hunter attaching freshly trimmed real foliage to the accessory.

FIG. 10 illustrates in side view an exemplary accessory including a weapon rack. Weapon rack 600 includes attachment plate 610, arm 612, and two padded, U shaped weapon holder details 620. FIG. 6 illustrates in front view the weapon rack of FIG. 5. Weapon rack 600 includes weapon holder details 620.

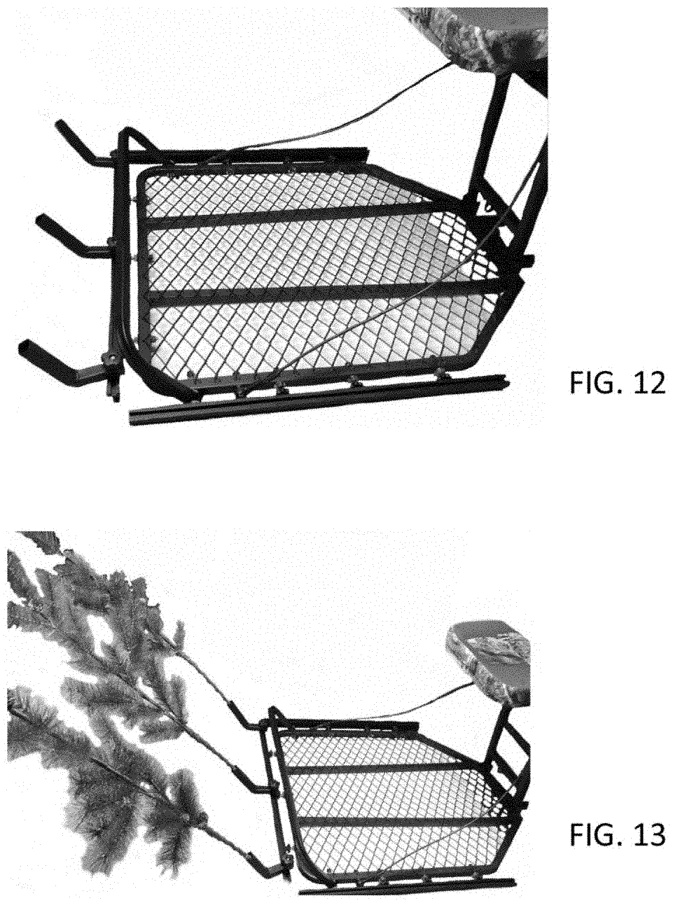

FIG. 12 illustrates photographically a tree stand including an accessory mounting rail system including a plurality of generic accessory attachment blocks. FIG. 12 illustrates an inverted U-shaped foot guard attached to either side of the platform of the tree stand and extending over a front end of the platform. FIG. 13 illustrates photographically the tree stand of FIG. 12 with three foliage decorations installed to the generic accessory attachment blocks.

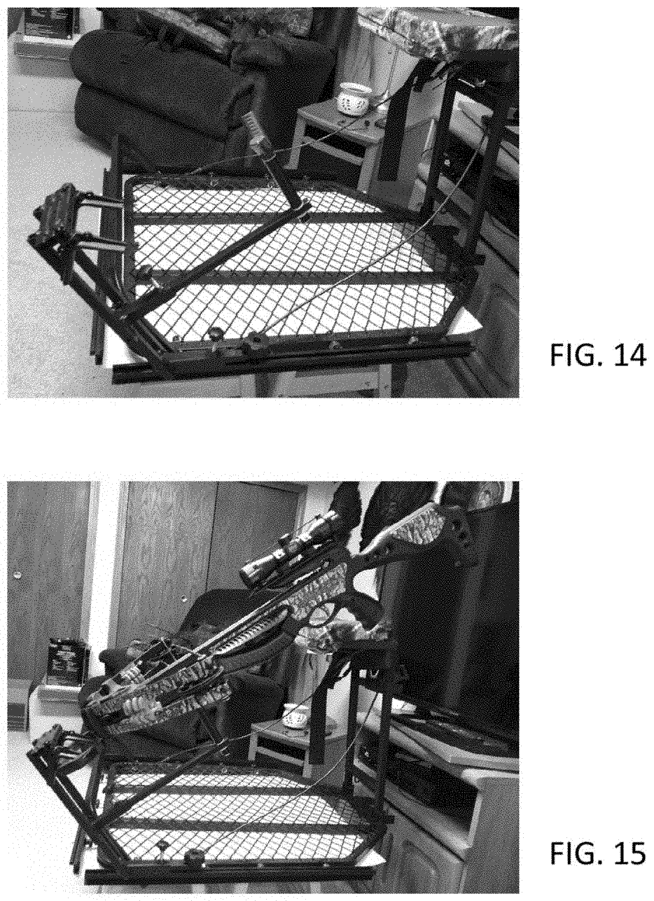

FIG. 14 illustrates photographically a tree stand including an accessory mounting rail system including an empty crossbow rack assembly. FIG. 15 illustrates photographically the tree stand of FIG. 14 with a crossbow loaded into the crossbow rack assembly.

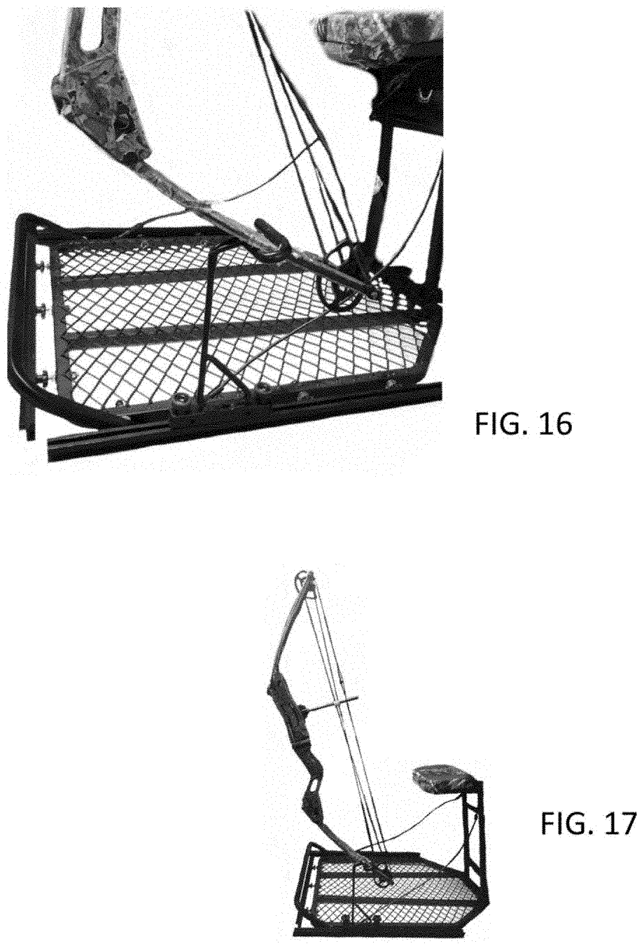

FIG. 16 illustrates photographically a tree stand including an accessory mounting rail system including a bow rack assembly. FIG. 17 illustrates photographically the tree stand of FIG. 16 with a bow loaded into the bow rack assembly.

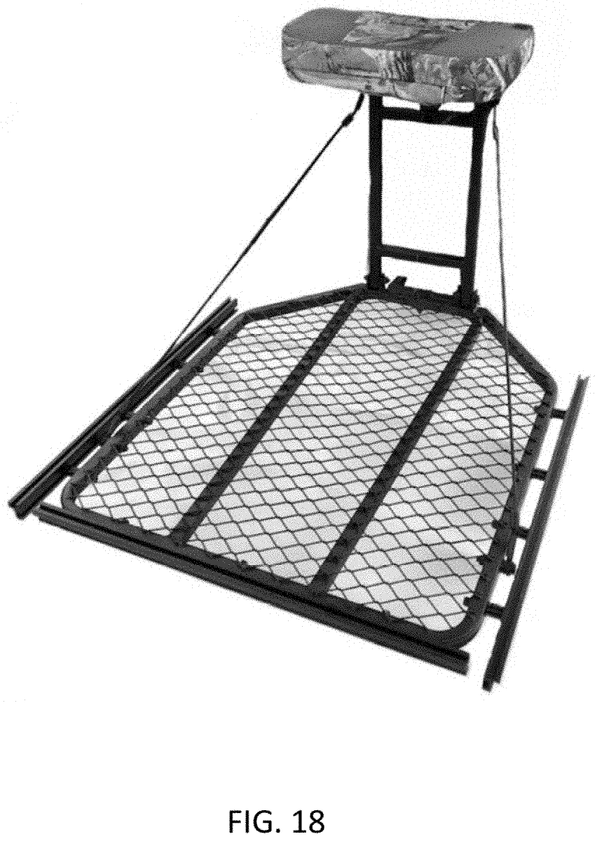

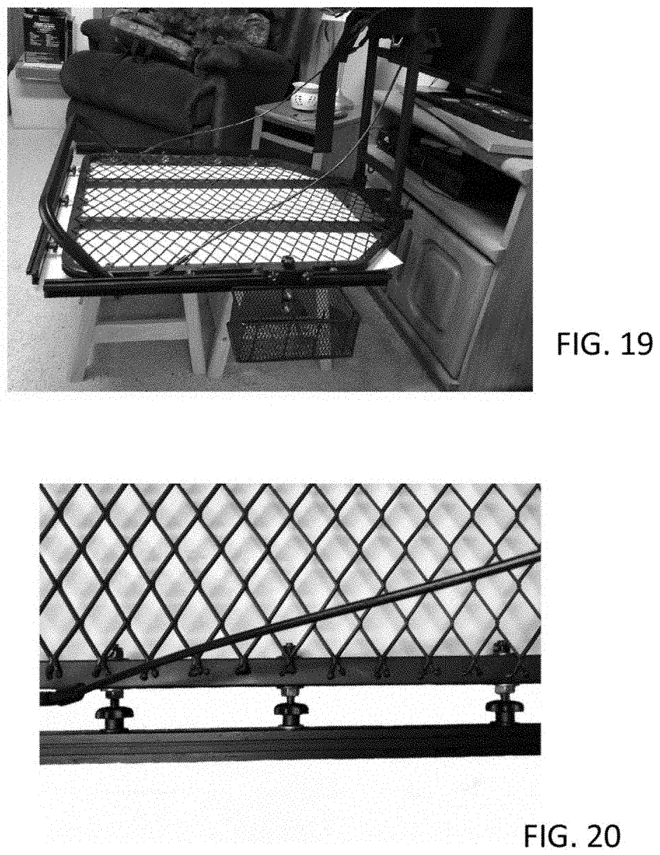

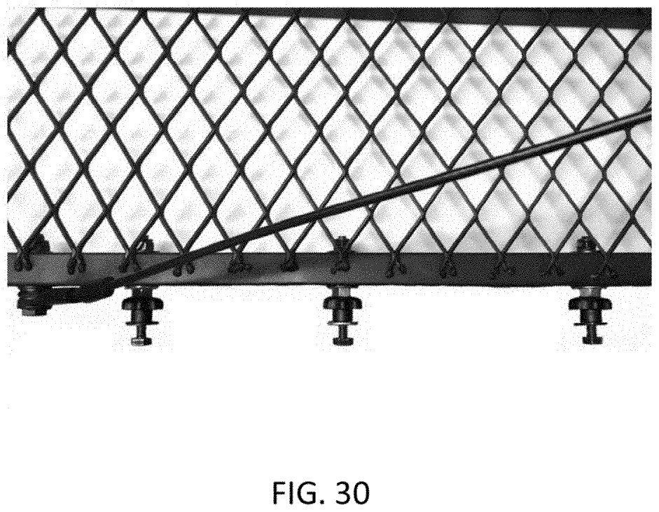

FIG. 18 illustrates photographically from a top view a tree stand including an accessory mounting rail system including rapid change fastener knobs. FIG. 19 illustrates photographically from a side view the tree stand of FIG. 18 with a knick-knack basket attached as an accessory. FIG. 20 illustrates photographically in a magnified scale the tree stand of FIG. 18, showing the rapid change fastener knobs in greater detail. FIG. 30 illustrates photographically the tree stand of FIG. 20, with the track rail removed for purposes of illustrating components of the rapid change fastener knobs.

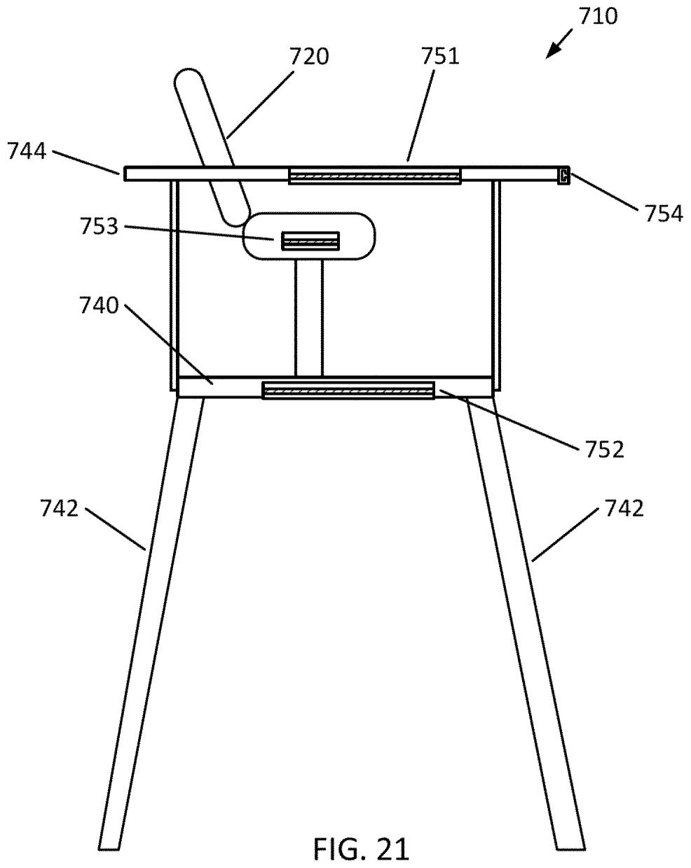

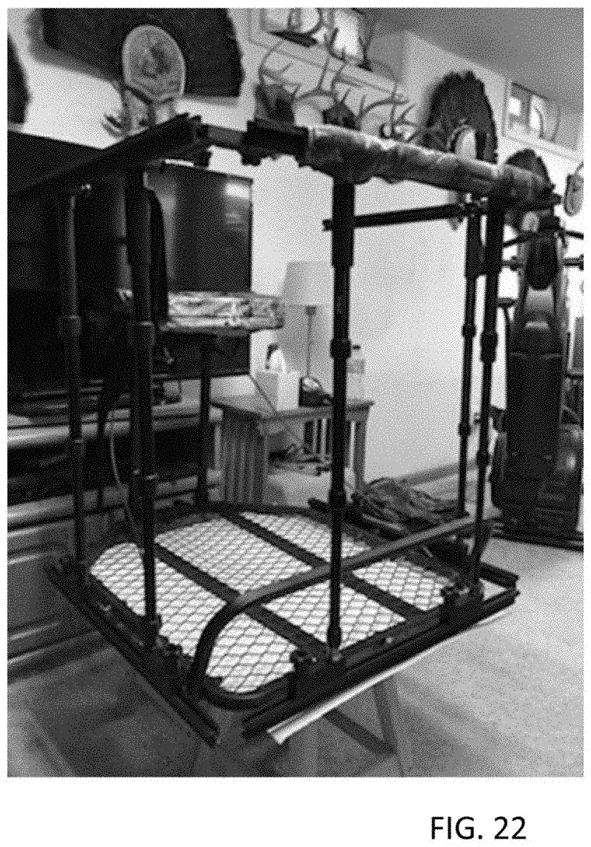

FIG. 21 illustrates an exemplary free-standing hunter stand including an accessory mounting rail system. Free-standing hunter stand 710 includes seat 720, platform 740, legs 742, and platform railing 744. Track rails 751, 752, 753, and 754 are illustrated at various points around stand 710.

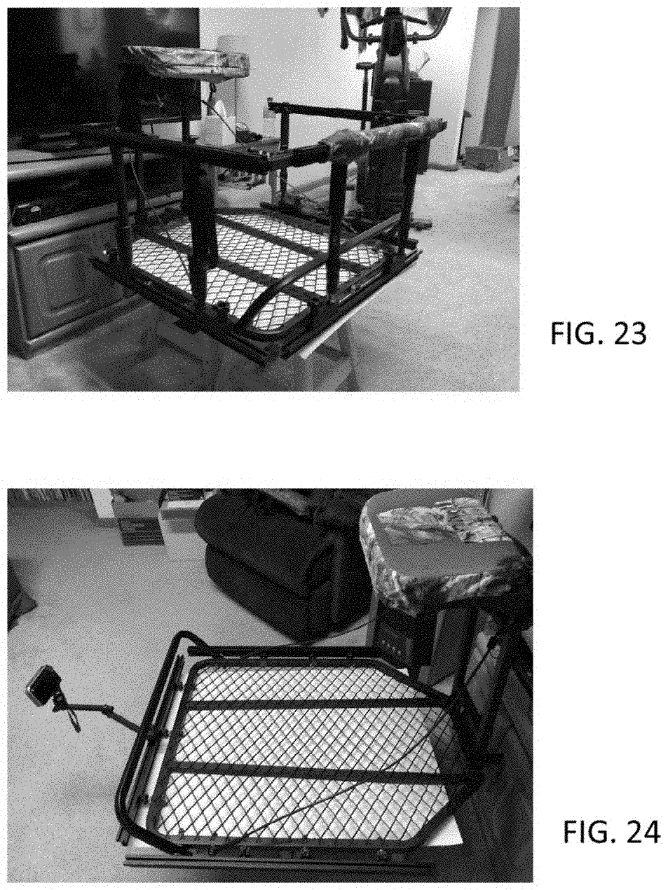

FIG. 22 illustrates photographically an alternative embodiment of a free-standing hunter stand including an accessory mounting rail system including adjustable height railings, with the railings in an upper position. FIG. 23 illustrates photographically the free-standing hunter stand of FIG. 22, with the railings in a lower position.

FIG. 24 illustrates photographically from a side view the tree stand of FIG. 18 with a camera device attached as an accessory.

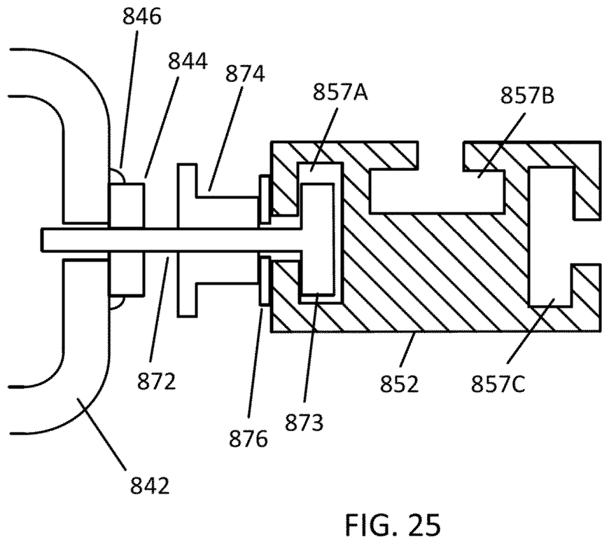

FIG. 25 illustrates in cross section an exemplary alternative configuration to the accessory mounting rail system of FIG. 20. Track rail 852 is illustrated in cross section, including channels 857A, 857B, and 857C. Perimeter tube 842 of a platform of a hunting stand is illustrated, including a threaded fastener nut 844 including welding joint 846 attaching nut 844 to perimeter tube 842. Nut 844 includes threading within a central hole. Post 872 is illustrated including a round head 873 located within channel 857A and attached rapid change fastener knob 874. As knob 874 is turned, post 872 rotates. Post 872 include threading which mates with the threading within nut 844, such that turning knob 874 engages or disengages post 872 with nut 844. Washer 876 facilitates easy turning of knob 874 relative to track rail 852. Knob 874 enables easy and rapid installation and removal of track rail 852 with the hunting stand.

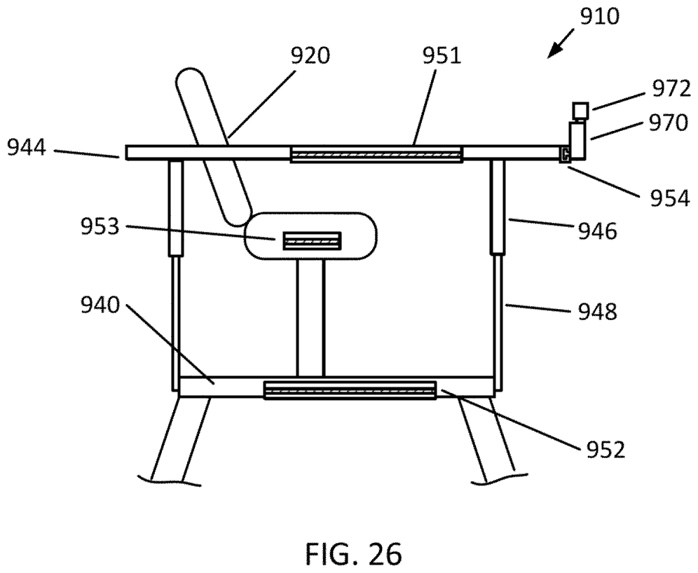

FIG. 26 illustrates in side view an exemplary alternative free-standing hunter stand including an accessory mounting rail system of FIG. 21, with adjustable height railings. Free-standing hunter stand 910 includes seat 920, platform 940, legs, and platform railing 944. Track rails 951, 952, 953, and 954 are illustrated at various points around stand 910. Railing 944 is supported by a plurality of railing support arms which each include mating, sliding supports 946 and 948, which slide against each other and permit adjustment of the height of railing 944 above platform 940. An exemplary accessory device 970 including a rifle supporting pivot platform 972 is provided, enabling a hunter to set a rifle upon platform 972 and steady the hunter's aim.

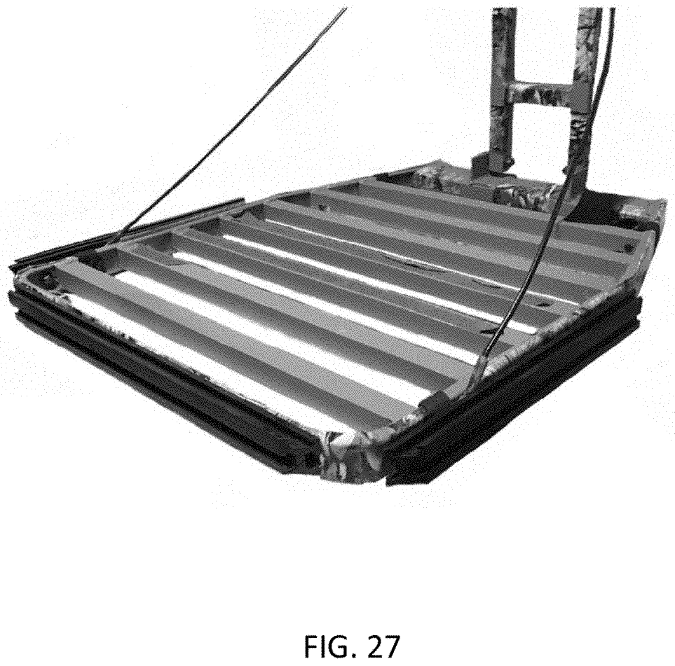

FIG. 27 illustrates photographically an exemplary alternative hunting stand including an alternative floor platform. Rectangular cross section bars are illustrated welded in place horizontally across the floor platform.

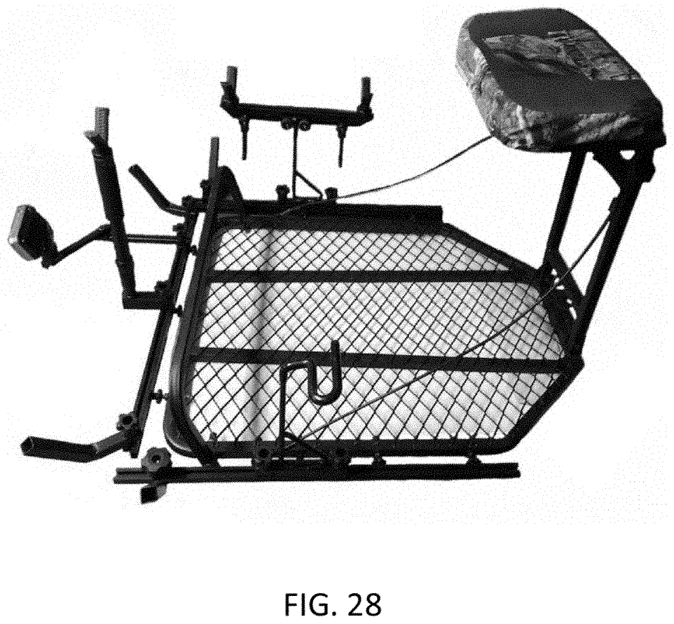

FIG. 28 illustrates photographically an exemplary alternative hunting stand including alternative exemplary accessories mounted thereto.

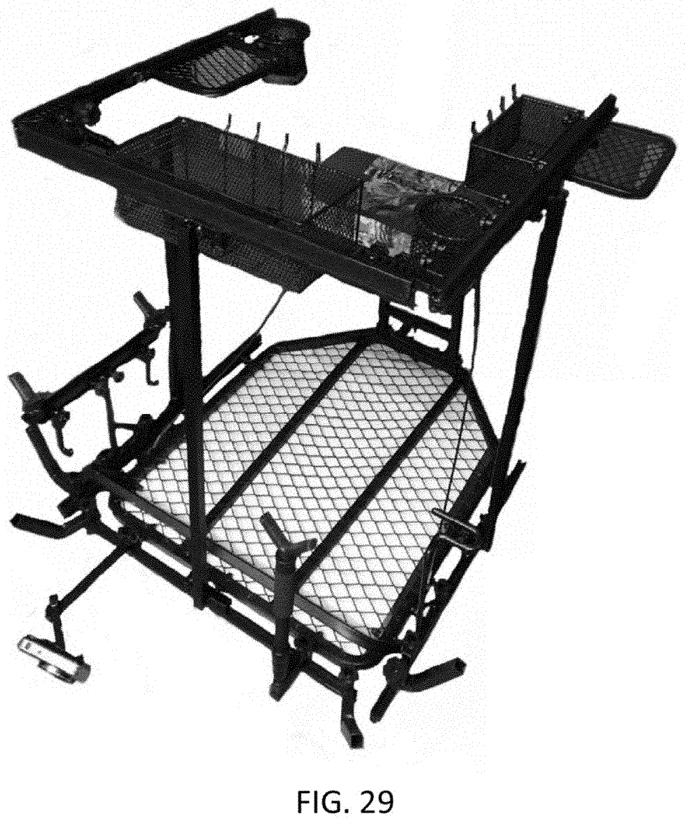

FIG. 29 illustrates photographically an additional exemplary alternative hunting stand including alternative exemplary accessories mounted thereto.

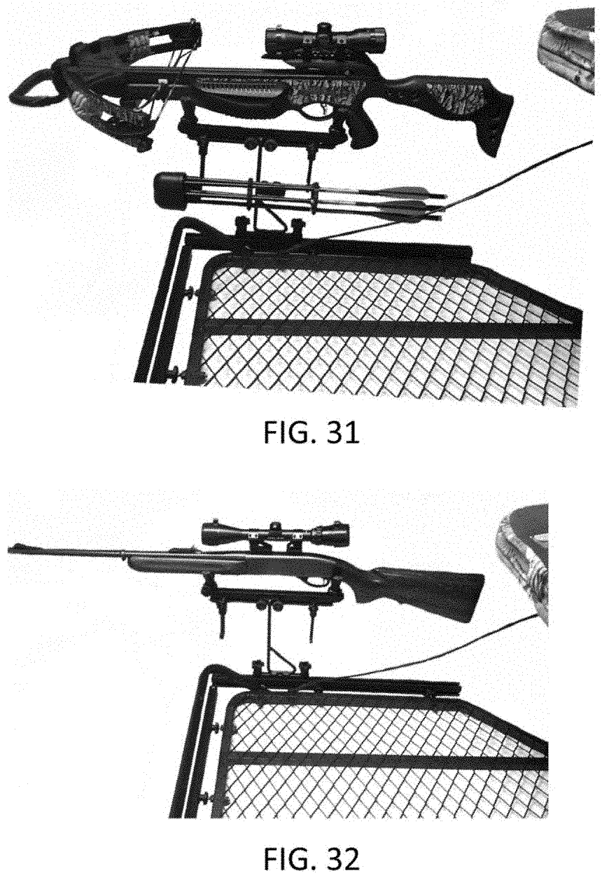

FIG. 31 illustrates photographically an additional exemplary alternative hunting stand including an exemplary crossbow rack and crossbow mounted thereto.

FIG. 32 illustrates photographically an additional exemplary alternative hunting stand including an exemplary rifle rack and rifle mounted thereto.

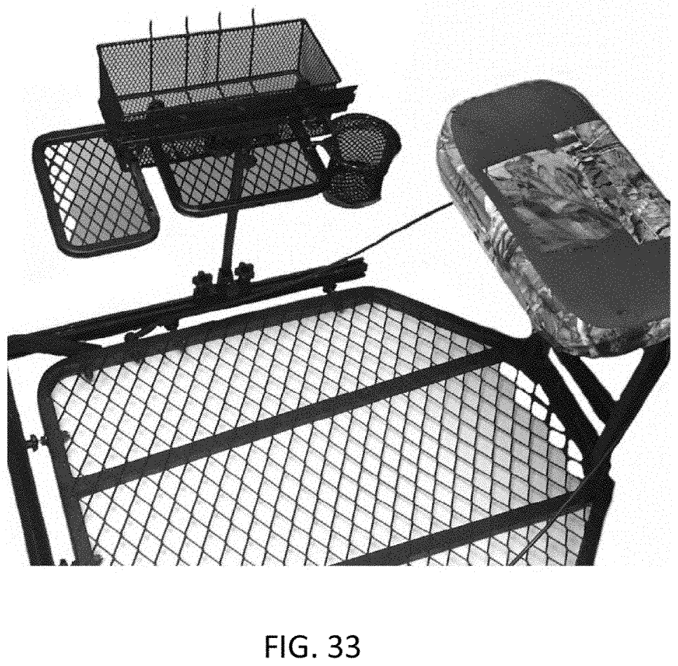

FIG. 33 illustrates photographically an additional exemplary alternative hunting stand including alternative exemplary accessories mounted thereto.

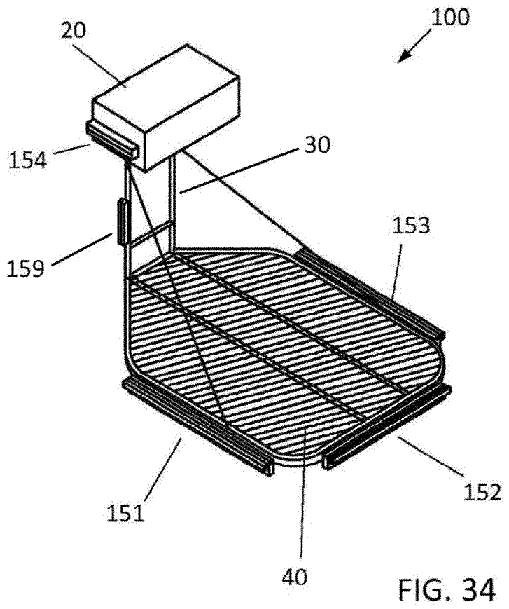

FIG. 34 illustrates the tree stand and accessory mounting rail system of FIG. 4, with a track rail mounted on the vertical strut of the tree stand. Tree stand 100 includes seat 20 suspended over platform 40 with vertical strut 30. Cables 32 are used to support platform 40. It will be appreciated that different structures in place of cables 32 can be used to connect platform 40 to strut 30 and similarly used to connect strut 30 to seat 20, including welded brackets and fastened support arms known in the art. An accessory mounting rail system is illustrated including track rails 151, 152, and 153 attached along a perimeter of platform 40. The accessory mounting rail system further includes track rail 154 mounted to a side of seat 20 and exemplary track rail 159 mounted to a portion of strut 30. It will be appreciated that similar track rails can be mounted at various places upon the illustrated tree stand or similar stands described herein.

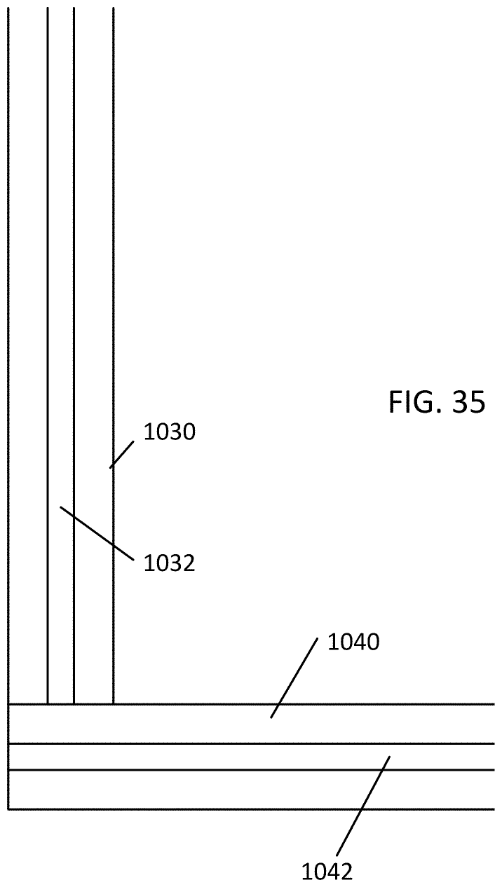

FIG. 35 illustrates an alternative version of the disclosed tree stand, with one or more of the structural members of the tree stand being formed with track rail members. An exemplary tree stand is shown in magnified view, illustrating from a side view where vertical struts 1030 are attached to platform 1040. Vertical strut 1030 is a track rail member, constructed with sufficient structural strength and rigidity to function as a part of the tree stand, supporting a seat above platform 1040 while still having fastener slot 1032 configured to permit attachment of accessories thereto. Similarly, platform 1040 is constructed with a track rail member also including fastener slot 1042. According to one description one can say that the track rails are formed integrally with the tree stand. In another embodiment, one can say that structural members of the tree stand are formed with track rails. Track rails can be used around various members of the disclosed tree stands, and the disclosure is not intended to be limited to the particular examples provided herein.

Track rails illustrated herein are provided as rails with common cross sections along a length of the track rails, such as can be created by an extrusion process. Track rails can be constructed in other ways including non-common cross sections in accordance with the disclosure.

The disclosure has described certain preferred embodiments and modifications of those embodiments. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. An apparatus comprising a hunting stand including an accessory mounting rail system, comprising:
the hunting stand; and
a track rail mounted to the hunting stand comprising an elongated fastener channel configured to mount an accessory thereto and permit the accessory to be moved along the elongated fastener channel.

2. The apparatus of claim 1, wherein the track rail comprises a single elongated fastener channel.

3. The apparatus of claim 1, wherein the track rail comprises a plurality of elongated fastener channels.

4. The apparatus of claim 1, further comprising a plurality of track rails mounted to the hunting stand.

5. The apparatus of claim 1, wherein the hunting stand comprises a nut welded to the hunting stand; and
wherein the track rail is mounted to the hunting stand with threaded post engaged to threading of the nut, the threaded post comprising a rapid change fastener knob attached to the threaded post and configured to turn the threaded post when the rapid change fastener knob is turned.

6. The apparatus of claim 1, further comprising an accessory device attached to the track rail.

7. The apparatus of claim 6, wherein the accessory device comprises foliage.

8. The apparatus of claim 6, wherein the accessory device comprises a weapon rack.

9. The apparatus of claim 6, wherein the accessory device comprises a knick-knack basket.

10. The apparatus of claim 6, wherein the accessory device comprises a cell phone holder.

11. The apparatus of claim 6, wherein the accessory device comprises a rifle supporting pivot platform.

12. The apparatus of claim 1, wherein the hunting stand comprises a tree stand.

13. The apparatus of claim 1, wherein the hunting stand comprises a free-standing hunter stand.

14. The apparatus of claim 13, wherein the free-standing hunter stand comprises adjustable height railings around the free-standing hunter stand.

15. The apparatus of claim 1, wherein the track rail comprises a structural member of the tree stand.

16. An apparatus comprising a hunting stand including an accessory mounting rail system, comprising:
a tree stand comprising a seat and a floor platform; and
a plurality of track rails mounted around a perimeter of the floor platform, each track rail comprising an elongated fastener channel configured to mount an accessory thereto and permit the accessory to be moved along the elongated fastener channel.

17. The apparatus of claim 16, further comprising an additional track rail mounted to the seat.

18. The apparatus of claim 16, wherein the tree stand further comprises a vertical strut connecting the seat and the platform; and
further comprising an additional track rail mounted to the vertical strut.

19. An apparatus comprising a hunting stand including an accessory mounting rail system, comprising:
a free-standing hunter stand comprising a seat, a floor platform, and a railing surrounding the floor platform; and
at least one track rail mounted to the railing, the track rail comprising an elongated fastener channel configured to mount an accessory thereto and permit the accessory to be moved along the elongated fastener channel.
